(19) United States
(12) Patent Application Publication
(10) Pub. No.: US 2024/0147361 A1
(43) Pub. Date: May 2, 2024

(54) METHOD AND APPARATUS FOR RESTRICTED TWT INFORMATION REQUEST

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/474,161

(22) Filed: Sep. 25, 2023

Related U.S. Application Data
(60) Provisional application No. 63/420,366, filed on Oct. 28, 2022.

(51) Int. Cl. H04W 52/02; H04W 48/08

(52) U.S. Cl. CPC H04W 52/0216; H04W 48/08

(57) ABSTRACT

Methods and apparatuses for facilitating requests for information on restricted target wake time (TWT) schedules in a wireless local area network. A wireless station (STA) device comprises a processor and a transceiver. The processor is operably coupled to the transceiver and configured to generate a first message that includes a request for information on existing broadcast TWT schedules in a basic service set (BSS). The transceiver is configured to transmit the first message to an associated access point (AP) in the BSS.

### CROSS-REFERENCE TO RELATED APPLICATION AND CLAIM OF PRIORITY

This application claims priority under 35 U.S.C. § 119(e) to U.S. Provisional Patent Application No. 63/420,366 filed on Oct. 28, 2022, which is hereby incorporated by reference in its entirety.

### TECHNICAL FIELD

This disclosure relates generally to power management in wireless communications systems that include multi-link devices. Embodiments of this disclosure relate to methods and apparatuses for facilitating requests for information on restricted Target Wake Time schedules in a wireless local area network communications system.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11 be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

Target wake time (TWT) is one of the most important features for power management in WI-FI networks, which was developed by IEEE 802.11ah and later adopted and modified into IEEE 802.1 lax. With TWT operation, it suffices fora STA to only wake up at a pre-scheduled time negotiated with another STA or AP in the network. In IEEE 802.11ax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

Restricted TWT (rTWT, r-TWT, or R-TWT) operation is a newly introduced feature in IEEE 802.11 be, which provides more protection for restricted TWT scheduled STAs in order to serve latency-sensitive applications in a timely manner. Restricted TWT is based on Broadcast TWT mechanisms, however, there are some key characteristics that make restricted TWT operation an important feature for supporting low-latency applications in next generation WLAN systems. Restricted TWT offers a protected service period for its member STAs by sending Quiet elements to other STAs in the basic service set (BSS) which are not members of the rTWT schedule, where the Quiet interval corresponding to the Quiet element overlaps with the initial portion of the restricted TWT service period (SP). Hence, it gives more channel access opportunities to the rTWT member scheduled STAs, which helps latency-sensitive traffic flows.

### SUMMARY

Embodiments of the present disclosure provide methods and apparatuses for facilitating requests for information on restricted TWT schedules in a WLAN.

In one embodiment, a wireless STA device is provided, comprising a transceiver and a processor operably coupled to the transceiver. The processor is configured to generate a first message that includes a request for information on existing broadcast TWT schedules in a BSS. The transceiver is configured to transmit the first message to an associated AP in the BSS.

In another embodiment, a method of wireless communication performed by a wireless STA device is provided. The method comprises the steps of generating a first message that includes a request for information on existing broadcast TWT schedules in a BSS, and transmitting the first message to an associated AP in the BSS.

In another embodiment, a wireless AP device is provided, comprising a transceiver and a processor operably coupled to the transceiver. The transceiver is configured to receive a first message from a STA in a BSS. The processor is configured to determine that the first message includes a request for information on existing broadcast TWT schedules in the BSS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example format of an R-TWT Information Request frame according to embodiments of the present disclosure;

FIG. 4 illustrates an example format of an R-TWT Information Request element in the R-TWT Information Request frame according to embodiments of the present disclosure;

FIG. 5 illustrates an example of usage of information carried in an R-TWT Information Request element according to embodiments of the present disclosure;

FIG. 6 illustrates an example format of an R-TWT Information Response frame according to embodiments of the present disclosure;

FIG. 7 illustrates an example format of an R-TWT element in the R-TWT Information Response frame according to embodiments of the present disclosure;

FIG. 8 illustrates an example operation of a non-AP STA using R-TWT Information Request and Response frames according to embodiments of the present disclosure;

FIG. 9 illustrates an example operation of an AP using R-TWT Information Request and Response frames according to embodiments of the present disclosure; and

FIG. 10 illustrates an example process for facilitating requests for information on broadcast and restricted TWT schedules in a WLAN according to various embodiments of the present disclosure.

### DETAILED DESCRIPTION

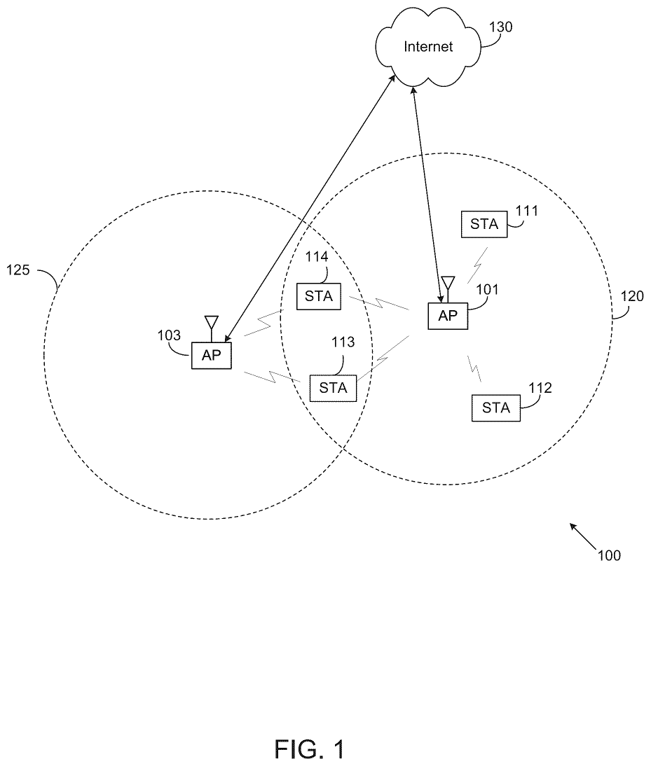

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that a TWT scheduled STA in a BSS receives information on currently available broadcast TWT schedules from Beacon frames transmitted by the AP of the BSS. The AP follows the TWT announcement procedures to advertise the TWT schedules it has in its BSS. If, however, the STA has latency-sensitive traffic then it may want to establish membership in an R-TWT schedule with the AP quickly—before the next Beacon frame will be sent. In such cases the STA can send a separate request asking for a new R-TWT schedule to be established. However, negotiation for a new R-TWT schedule may take longer than negotiation to become a member of an existing R-TWT schedule. If there are already some existing R-TWT schedules in the BSS that match the STA's latency-sensitive traffic pattern, then it would be better for the STA to try to obtain membership to one of those R-TWT schedules.

When the STA intends to establish membership to an R-TWT schedule, the STA may not have the information on the currently available R-TWT at that time. The STA then has two options. First, wait for the next Beacon frame to be transmitted which will contain the information on the existing R-TWT schedules in the BSS. However, this may delay the STA's latency-sensitive applications. Second, send a Probe Request frame to receive the information on the existing R-TWT schedules in the BSS from the AP. However, this will incur large additional overhead associated with Probe Response frames when the STA just needs the information pertaining to the TWT schedules.

Currently, there is no mechanism available that would enable a STA to directly request R-TWT schedule information from the AP. Accordingly, embodiments of the disclosure provide mechanisms for facilitating requests by a STA for information on existing R-TWT schedules in a BSS from an AP. It is understood that since a restricted TWT schedule is a variant of a broadcast TWT schedule, these embodiments could also apply to requests for broadband TWT schedules.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating requests for information on restricted TWT schedules in a WLAN. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

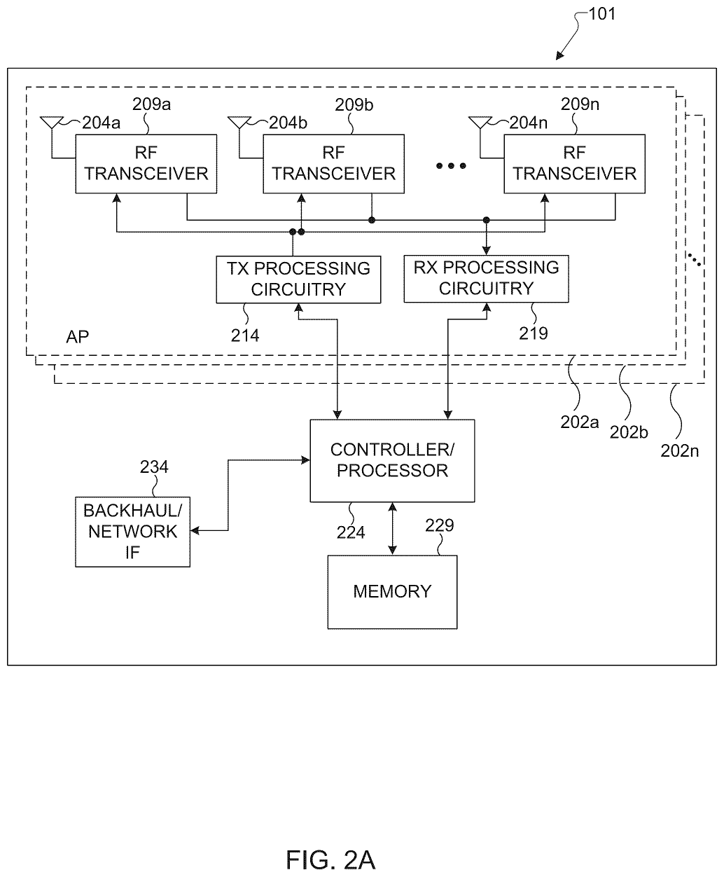

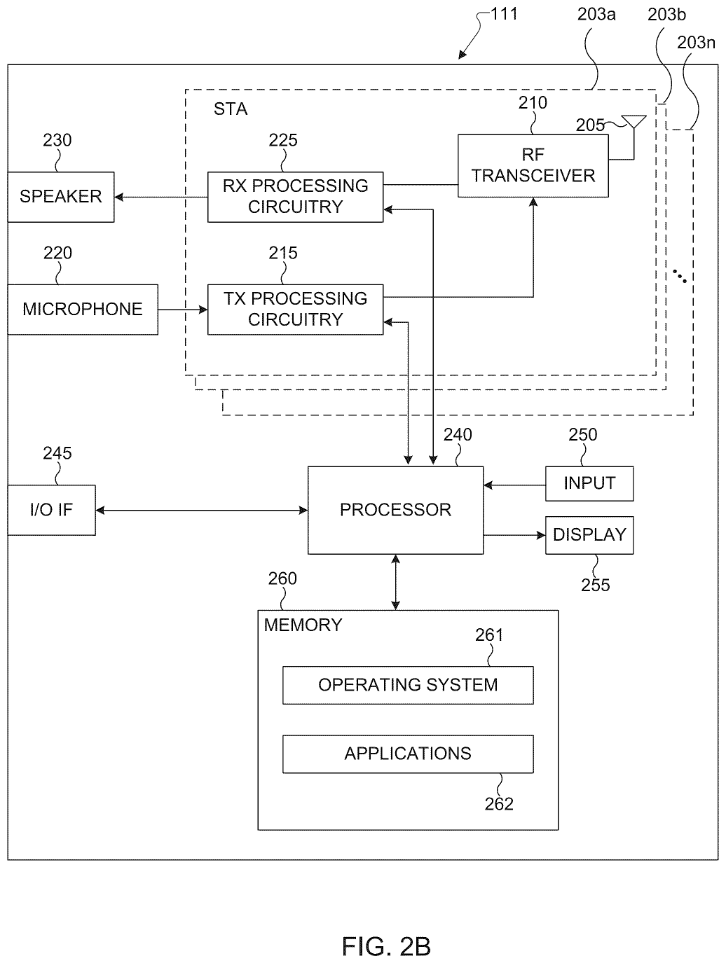

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating requests for information on restricted TWT schedules in a WLAN. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating requests for information on restricted TWT schedules in a WLAN. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate requests for information on restricted TWT schedules in a W LAN. In some embodiments, the controller/processor 240 includes at least one microprocessor or microcontroller.

The controller/processor 240 is also capable of executing other processes and programs resident in the memory 260, such as operations for facilitating requests for information on restricted TWT schedules in a WLAN. The controller/processor 240 can move data into or out of the memory 260 as required by an executing process. In some embodiments, the controller/processor 240 is configured to execute a plurality of applications 262, such as applications for facilitating requests for information on restricted TWT schedules in a WLAN. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure provided below illustrate mechanisms by which a STA may request information on existing R-TWT schedules in a BSS from an AP. It is understood that since a restricted TWT schedule is a variant of a broadcast TWT schedule, these embodiments could also apply to requests for broadband TWT schedules.

According to one embodiment, a non-AP STA can send a request to its associated AP seeking information about the R-TWT schedules currently available in the BSS. The STA can request R-TWT information for a multitude of purposes, such as when the STA has latency-sensitive traffic and the STA intends to establish membership in an existing R-TWT schedule, or when the STA is already a member of an existing R-TWT schedule and the STA intends to change some of the R-TWT parameters corresponding to the schedule (e.g., change the R-TWT service period (SP) duration, periodicity, or target wake time).

Upon observing the R-TWT schedules currently available in the BSS, the STA can decide whether to send a request to join any of these existing R-TWT schedules or send a request to the R-TWT scheduling AP to create a new R-TWT schedule that matches the traffic requirement of the STA.

According to one embodiment, upon receiving an R-TWT Information Request from a non-AP STA, the AP can provide the TWT information to the information-requesting STA. According to one embodiment, upon receiving the request, the AP can send the entire broadcast TWT element containing information on all broadcast TWT schedules including the restricted TWT schedules—that is, each Broadcast TWT Parameter set for each broadcast TWT schedule would be included in the TWT element. According to another embodiment, upon receiving the request from the STA, the AP can include only information on the R-TWT schedules in the TWT element that it sends to the STA. According to this embodiment, in the Broadcast TWT element, the AP only includes the TWT parameter sets corresponding to the R-TWT schedules.

According to one embodiment, a STA can send an implicit request for R-TWT schedule information. For example, if a STA supports R-TWT operation, then during the association with the AP, the AP can send the STA all the related R-TWT schedule information (this set of R-TWT schedule information may consist of the R-TWT schedules the AP is maintaining in its BSS). The AP may provide the R-TWT schedule information to the STA by including it in a TWT element in the Probe Response frame or any other individually addressed frame transmitted to the STA. The TWT element would include Broadcast TWT Parameter sets corresponding to the existing R-TWT schedules. While providing the R-TWT schedule information to the STA, the AP may not provide the information related to R-TWT schedules that are full R-TWT schedules (i.e., R-TWT schedules with full membership).

According to one embodiment, a STA that intends to establish membership in an R-TWT schedule, and to request existing R-TWT schedule information for that purpose, may send an R-TWT Information Request frame to its associated AP. The R-TWT Information Request frame can be an individually addressed frame. According to one embodiment, the R-TWT Information Request frame can be a Control frame or a Management frame. According to another embodiment, an A-Control subfield can also be used to indicate such an R-TWT Information Request. According to one embodiment, a subfield (for example, a one-bit subfield) can be used to indicate the request made to the AP. If the subfield is set to 1, it can indicate that the STA is requesting R-TWT Information from the R-TWT scheduling AP. Otherwise, the STA is not requesting R-TWT Information from the R-TWT scheduling AP.

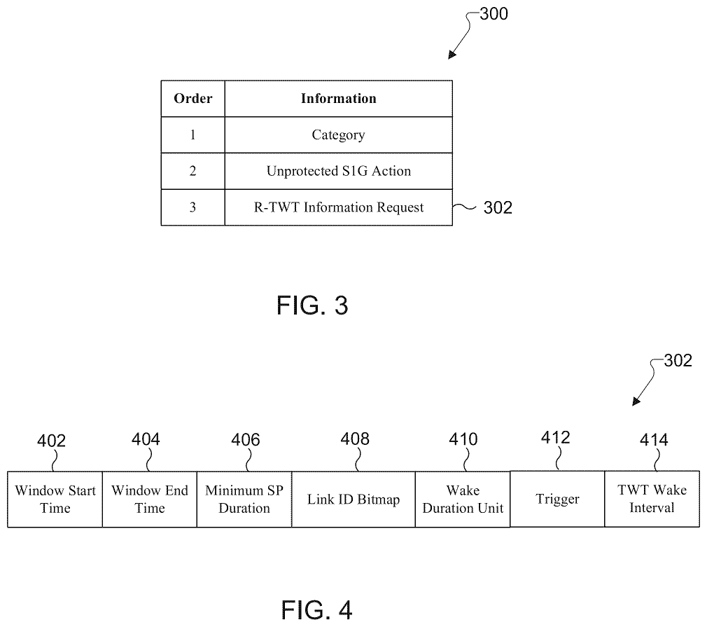

FIG. 3 illustrates an example format of an R-TWT Information Request frame 300 according to embodiments of the present disclosure. In this example, the R-TWT Information Request frame 300 includes an R-TWT Information Request element 302.

FIG. 4 illustrates an example format of an R-TWT Information Request element 302 in the R-TWT Information Request frame 300 according to embodiments of the present disclosure. In the example of FIG. 4, the Window Start Time subfield 402 and the Window End Time subfield 404 together specify a range of time instances. The Window Start Time indicates the starting point of the range and the Window End Time indicates the end point of the range. This range of time instances indicates to the R-TWT scheduling AP that the R-TWT information-requesting STA is requesting information on the R-TWT schedules whose Target Wake Times (TWTs) fall within this range.

The Minimum SP Duration subfield 406 in the R-TWT Information Request element 302 indicates that the STA is requesting information for those R-TWT schedules in the BSS that have an SP duration of at least the SP duration indicated in the Minimum SP Duration subfield 406.

The Link ID Bitmap subfield 408 in the R-TWT Information Request element 302 indicates that the STA is requesting information for those R-TWT schedules that currently exist on the link indicated in the Link ID Bitmap subfield 408 (e.g., for MLDs operating under MLO). If the bit position i in the Link ID Bitmap subfield 408 is set to 1, it would indicate that the R-TWT information requesting STA is requesting information for the R-TWT schedules available on Link i. Otherwise, the R-TWT information requesting STA is not requesting information for the R-TWT schedules available on Link i.

The Wake Duration Unit subfield 410 indicates the unit of the Minimum SP Duration subfield 406.

the Trigger subfield 412 indicates whether or not the STA is requesting R-TWT schedules that are Trigger-enabled TWT schedules. If the Trigger subfield 412 is set to 1, it indicates that the R-TWT Information-requesting STA is only requesting information for the R-TWT schedules that are trigger-enabled. If the Trigger subfield 412 is set to 0, according to one embodiment, it can indicate that the R-TWT Information-requesting STA is requesting information on R-TWT schedules that are not trigger-enabled. According to another embodiment, if the Trigger subfield 412 is set to 0, it can indicate that the R-TWT Information-requesting STA is requesting information on both trigger-enabled and non-trigger-enabled R-TWT schedules.

According to one embodiment, the TWT Wake Interval subfield 414 can indicate that the R-TWT Information-requesting STA is requesting information for the R-TWT schedules in the BSS that have a TWT wake interval that matches the TWT wake interval indicated in the TWT Wake Interval subfield 414. According to another embodiment, the TWT Wake Interval subfield 414 can indicate that the R-TWT Information-requesting STA is requesting information for the R-TWT schedules in the BSS that have a TWT wake interval that is at most the value indicated in the TWT Wake Interval subfield 414.

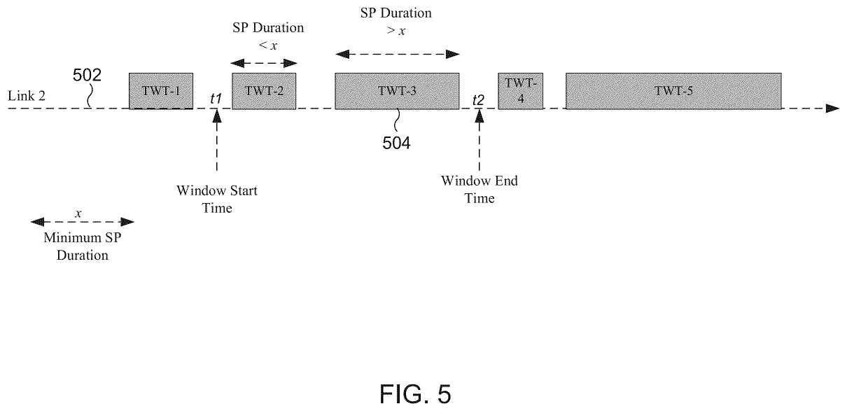

FIG. 5 illustrates an example of usage of information carried in an R-TWT Information Request element according to embodiments of the present disclosure. The link 502 in the example of FIG. 5 may represent a link between two MLDs. For example, in the case of an AP MLD 101 and a non-AP MLD 111, where STA1 and STA2 are affiliated with the non-AP MLD and AP1 and AP2 are affiliated with the AP MLD, STA1 is associated with AP1 and is operating on Link 1, and STA2 is associated with AP2 and is operating on Link 2, the link 502 may correspond to Link 2.

In this example, the non-AP MLD intends to obtain membership in an R-TWT schedule on Link 2. Towards that end, STA1 sends an R-TWT Information Request frame (not illustrated) to AP1. In the R-TWT Information Request element, STA1 indicates that it is requesting information on R-TWT schedules that are available on Link 2 that have a Target Wake Time that falls within the range of time 11 and time 12 (i.e., with Window Start Time set to t1 and Window End Time set to t2) and a minimum TWT SP duration of x. In FIG. 5, the R-TWT schedule TWT-3 on Link 2 (the TWT schedule 504) fulfills the criteria indicated in the R-TWT Information Request frame. Hence, AP1 sends to STA1 the information pertaining to R-TWT schedule TWT-3.

According to one embodiment, upon receiving an R-TWT Information Request frame from a STA, the R-TWT scheduling AP can simply send a TWT Setup frame to the STA containing a TWT element that contains either (i) Broadcast TWT Parameter sets corresponding to all existing broadcast TWT schedules, or (ii) Broadcast TWT Parameter sets corresponding to only the existing restricted TWT schedules. According to another embodiment, the AP can respond with an R-TWT Information Response frame containing the necessary information related to the R-TWT schedules.

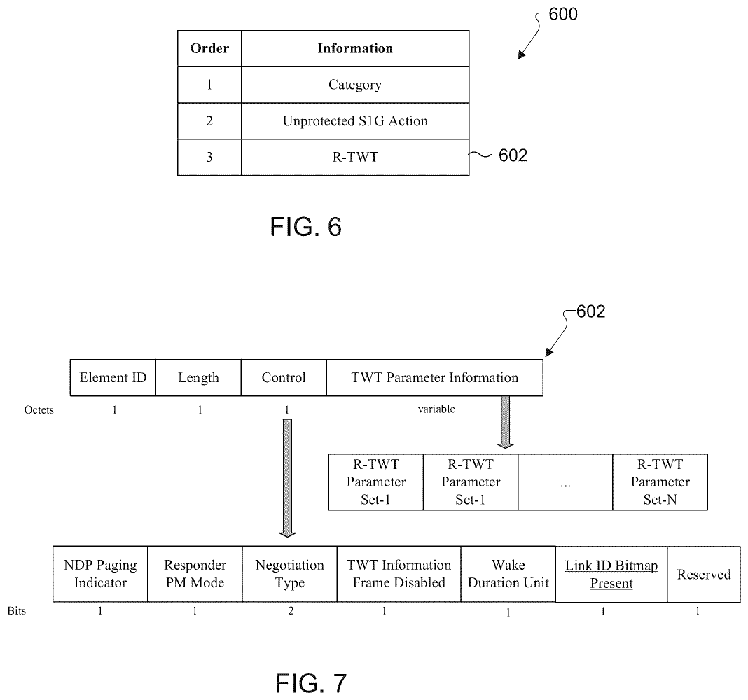

FIG. 6 illustrates an example format of an R-TWT Information Response frame 600 according to embodiments of the present disclosure. In this example, the R-TWT Information Response frame 600 includes an R-TWT element 602. The R-TWT element 602 can contain information related to the R-TWT schedules that satisfy the criteria indicated in the received R-TWT Information Request frame. For example, in reference to the FIG. 5, the AP would only include information on the R-TWT schedule TWT-3 (e.g., the R-TWT parameter set corresponding to schedule TWT-3).

FIG. 7 illustrates an example format of an R-TWT element 602 in the R-TWT Information Response frame 600 according to embodiments of the present disclosure.

According to one embodiment, any STA that is associated with the AP can send the R-TWT Information Request frame to the AP. According to another embodiment, STAs that have previously set up an R-TWT schedule can send the R-TWT Information Request frame. According to another embodiment, STAs that have previously shared a QoS Characteristics element or established subcarrier spacing (SCS) with the AP can send the R-TWT Information Request frame to the AP.

According to one embodiment, upon receiving an R-TWT Information Request frame from a STA, if the AP determines that there is no currently available R-TWT schedule that fulfills the criteria indicated in the R-TWT Information Request frame, then the AP doesn't send any response frame to the STA in response to the received R-TWT Information Request frame. According to another embodiment, in the above scenario the AP can send a response frame (e.g., a control frame or any other short frame) to the STA indicating that there is no currently available R-TWT schedule in the BSS that matches the criteria indicated in the R-TWT Information Request frame.

According to one embodiment, if a STA receives an R-TWT Information Response frame containing information of one or more R-TWT schedules that match the criteria indicated in the R-TWT Information Request frame sent by the STA, then the STA can subsequently send a TWT request to the R-TWT scheduling AP requesting to establish membership in one of those existing R-TWT schedules. According to another embodiment, if the STA doesn't receive any R-TWT Information Response frame as a response to the previously sent R-TWT Information Request frame or if the STA receives an indication from the AP that there is no existing R-TWT schedule that fulfills the criteria indicated in the previously sent R-TWT Information Response frame, then the STA can determine to send a request to the AP to create a new R-TWT schedule for the STA that matches the latency-sensitive traffic requirement of the STA.

According to one embodiment, in the case of MLO operation the R-TWT Information Request frame can be sent on the link for which the R-TWT information is sought. For example, if information on the R-TWT schedules available on Link 1 is sought, then the R-TWT Information Request frame is sent on Link 1. According to another embodiment, the R-TWT Information Request frame can be sent on a different link than the link for which the R-TWT information is sought. For example, if information on the R-TWT schedules available on Link 1 is sought, then the R-TWT Information Request frame can be sent on Link 2. According to one embodiment, the link for which the R-TWT information is requested can be indicated by including a Multi-link Link Indication element in the R-TWT Information Request frame. Alternatively, such indication can be made in the Link ID Bitmap subfield in R-TWT Information Request element.

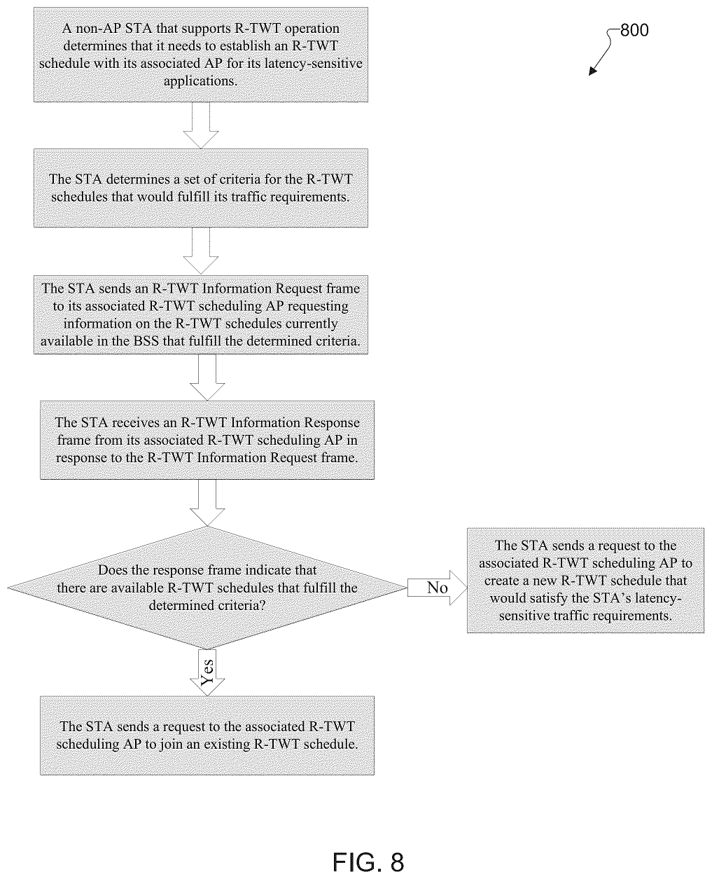

FIG. 8 illustrates an example operation 800 of a non-AP STA using R-TWT Information Request and Response frames according to embodiments of the present disclosure.

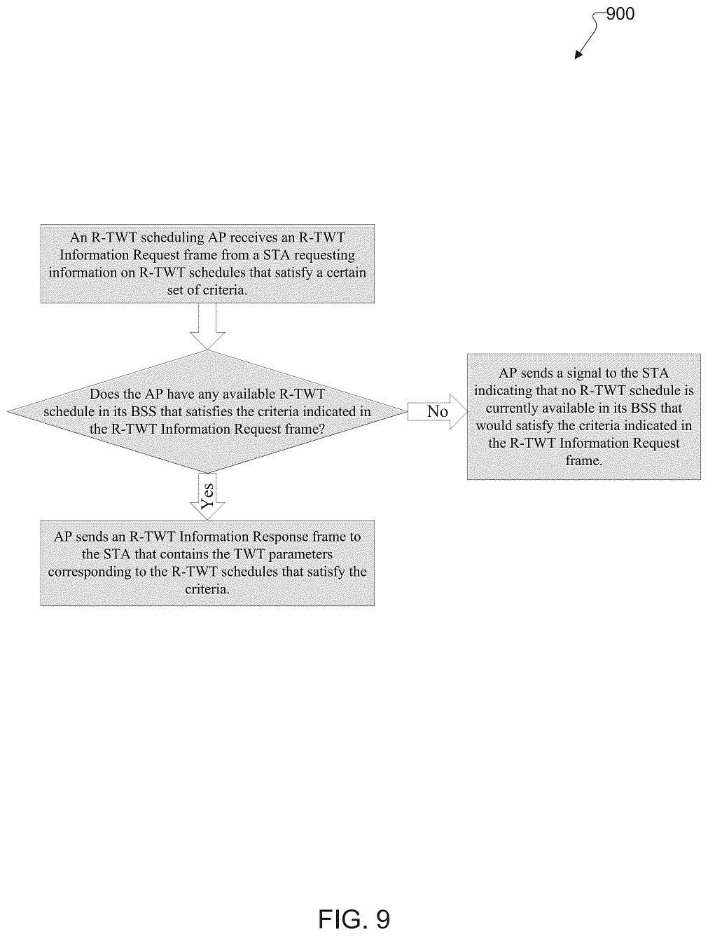

FIG. 9 illustrates an example operation 900 of an AP using R-TWT Information Request and Response frames according to embodiments of the present disclosure.

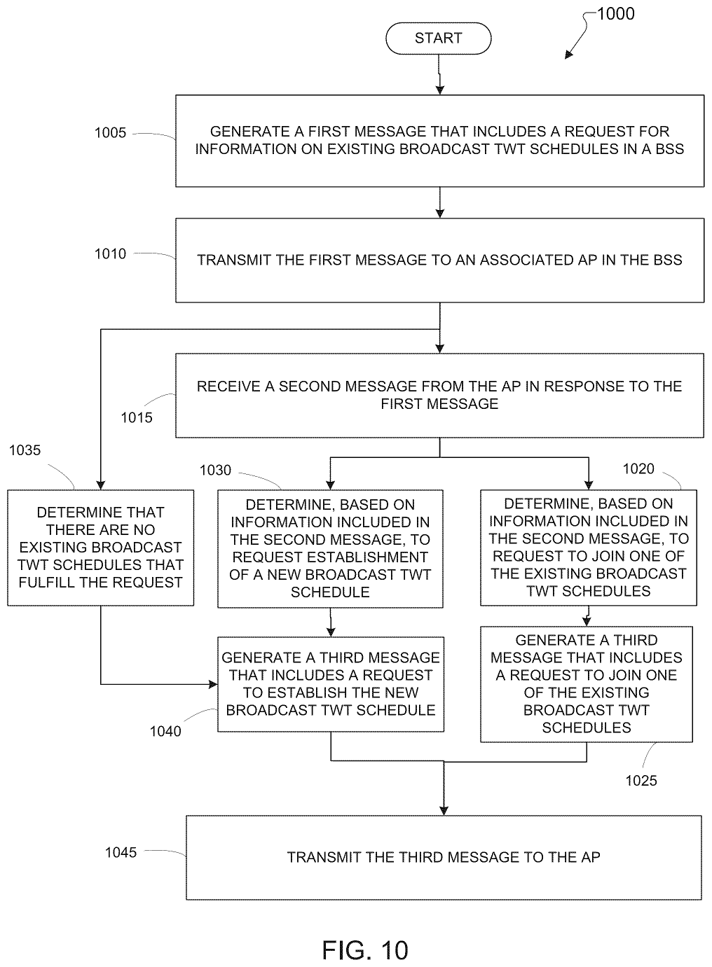

FIG. 10 illustrates an example process 1000 for facilitating requests for information on broadcast and restricted TWT schedules in a WLAN according to various embodiments of the present disclosure. The process 1000 of FIG. 10 is discussed as being performed by a STA, but it is understood that a corresponding AP performs a corresponding process. Additionally, for convenience the process of FIG. 10 is discussed as being performed by a wireless WI-FI STA device comprising a processor and a transceiver, but it is understood that any suitable wireless communication device could perform this process.

Referring to FIG. 10, the process 1000 begins with the STA generating a first message that includes a request for information on existing broadcast TWT schedules in a BSS (step 1005). The request may include an indication that the request is for information on restricted TWT schedules, an indication that the request is for information on both restricted TWT schedules and non-restricted broadcast TWT schedules, or TWT parameter criteria and an indication that the request is for information on TWT schedules that meet the criteria. The first message may be, for example, an R-TWT Information Request frame.

Next, the STA transmits the first message to an associated AP in the BSS (step 1010). In some embodiments, prior to transmitting the first message to the AP the STA must have established membership in a restricted TWT schedule with the AP, shared QoS characteristics with the AP, or established stream classification service (SCS) with the AP.

In some embodiments, the STA receives a second message from the AP in response to the first message (step 1015). The second message may include information on the existing broadcast TWT schedules that fulfill the request, or lack thereof. The second message may be, for example, an R-TWT Information Response frame.

If the second message includes information on existing broadcast TWT schedules, then based on that information the STA may determine to request to join one of the existing broadcast TWT schedules (step 1020). This may include, for example, determining that the TWT parameters of one of the existing broadcast TWT schedules meet the latency requirements of latency-sensitive traffic generated at the STA.

In this case, the STA generates a third message that includes a request to join one of the existing broadcast TWT schedules based on the information included in the second message (step 1025).

In other embodiments in which the second message includes information on existing broadcast TWT schedules, the STA may determine, based on that information, to request establishment of a new broadcast TWT schedule (step 1030). This may include, for example, determining that there are no existing broadcast TWT schedules that fulfill the request of the first message (e.g., none of the existing broadcast TWT schedules have TWT parameters that meet the latency requirements of latency-sensitive traffic generated at the STA).

Alternatively, the STA may determine that there are no existing broadcast TWT schedules that fulfill the request of the first message by other means (step 1035). For example, the STA may determine that no response to the first message has been received from the AP, and may infer that the AP did not send a response to the request because there are no existing broadcast TWT schedules that fulfill the request. Similar to step 1030, the STA may determine to request establishment of a new broadcast TWT schedule in this case.

After step 1030 or step 1035, the STA generates a third message that includes a request to establish the new broadcast TWT schedule (step 1040).

After generation of a third message at step 1025 or step 1040, the STA transmits the third message to the AP (step 1045).

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A wireless station (STA) device comprising:
a transceiver; and
a processor operably coupled to the transceiver, the processor configured to generate a first message that includes a request for information on existing broadcast target wake time (TWT) schedules in a basic service set (BSS),
wherein the transceiver is configured to transmit the first message to an associated access point (AP) in the BSS.

2. The STA of claim 1, wherein the request includes:
an indication that the request is for information on restricted TWT schedules,
an indication that the request is for information on both restricted TWT schedules and non-restricted broadcast TWT schedules, or
TWT parameter criteria and an indication that the request is for information on TWT schedules that meet the TWT parameter criteria.

3. The STA of claim 1, wherein:
the transceiver is further configured to receive a second message from the AP in response to the first message, and
the second message includes information on the existing broadcast TWT schedules that fulfill the request.

4. The STA of claim 3, wherein:
the processor is further configured to generate a third message that includes a request to join one of the existing broadcast TWT schedules based on the information included in the second message, and
the transceiver is further configured to transmit the third message to the AP.

5. The STA of claim 3, wherein:
the processor is further configured to:
determine, based on the information included in the second message, to request establishment of a new broadcast TWT schedule; and
generate a third message that includes a request to establish the new broadcast TWT schedule, and
the transceiver is further configured to transmit the third message to the AP.

6. The STA of claim 1, wherein the processor is further configured to determine that there are no existing broadcast TWT schedules that fulfill the request, based on either:
information in a second message received from the AP in response to the first message, or
a determination that no response to the first message has been received from the AP.

7. The STA of claim 1, wherein prior to transmitting the first message to the AP:
the STA has established membership in a restricted TWT schedule with the AP, or
the STA has shared quality of service (QoS) characteristics with the AP or has established stream classification service (SCS) with the AP.

8. A method of wireless communication performed by a wireless station (STA) device, the method comprising:
generating a first message that includes a request for information on existing broadcast target wake time (TWT) schedules in a basic service set (BSS); and
transmitting the first message to an associated access point (AP) in the BSS.

9. The method of claim 8, wherein the request includes:
an indication that the request is for information on restricted TWT schedules,
an indication that the request is for information on both restricted TWT schedules and non-restricted broadcast TWT schedules, or
TWT parameter criteria and an indication that the request is for information on TWT schedules that meet the TWT parameter criteria.

10. The method of claim 8, further comprising:
receiving a second message from the AP in response to the first message,
wherein the second message includes information on the existing broadcast TWT schedules that fulfill the request.

11. The method of claim 10, further comprising:
generating a third message that includes a request to join one of the existing broadcast TWT schedules based on the information included in the second message; and
transmitting the third message to the AP.

12. The method of claim 10, further comprising:
determining, based on the information included in the second message, to request establishment of a new broadcast TWT schedule;
generating a third message that includes a request to establish the new broadcast TWT schedule; and
transmitting the third message to the AP.

13. The method of claim 8, further comprising determining that there are no existing broadcast TWT schedules that fulfill the request, based on either:
information in a second message received from the AP in response to the first message, or
a determination that no response to the first message has been received from the AP.

14. The method of claim 8, wherein prior to transmitting the first message to the AP:
the STA has established membership in a restricted TWT schedule with the AP, or
the STA has shared quality of service (QoS) characteristics with the AP or has established stream classification service (SCS) with the AP.

15. An access point (AP) device, comprising:
a transceiver configured to receive a first message from a station (STA) in a basic service set (BSS); and
a processor operably coupled to the transceiver, the processor configured to determine that the first message includes a request for information on existing broadcast target wake time (TWT) schedules in the BSS.

16. The AP of claim 15, wherein the request includes:
an indication that the request is for information on restricted TWT schedules,
an indication that the request is for information on both restricted TWT schedules and non-restricted broadcast TWT schedules, or
TWT parameter criteria and an indication that the request is for information on TWT schedules that meet the TWT parameter criteria.

17. The AP of claim 15, wherein:
the processor is further configured to generate a second message that includes information on the existing broadcast TWT schedules that fulfill the request, and
the transceiver is further configured to transmit the second message to the STA in response to the first message.

18. The AP of claim 17, wherein:
the transceiver is further configured to receive a third message from the STA, and
the processor is further configured to:
determine that the third message includes a request to join one of the existing broadcast TWT schedules based on the information included in the second message, or
determine that the third message includes a request to establish a new broadcast TWT schedule.

19. The AP of claim 15, wherein:
the processor is further configured to:
generate a second message that includes an indication that there are no existing broadcast TWT schedules that fulfill the request; or
determine, based on a determination that there are no existing broadcast TWT schedules that fulfill the request, not to respond to the first message, and
the transceiver is further configured to:
transmit the second message to the STA based on the second message being generated; or
refrain from transmitting to the STA a response to the first message.

20. The AP of claim 15, wherein prior to receiving the first message from the STA:
the STA has established membership in a restricted TWT schedule with the AP, or
the STA has shared quality of service (QoS) characteristics with the AP or has established stream classification service (SCS) with the AP.
